(19) United States
(12) Patent Application Publication
(10) Pub. No.: US 2011/0148884 A1
(43) Pub. Date: Jun. 23, 2011

(54) System and method for determining motion of a subject

(76) Inventor: Charles Timberlake Zeleny, Baltimore, MD (US)

(21) Appl. No.: 12/654,325

(22) Filed: Dec. 17, 2009

(51) Int. Cl. G06T 11/20; G10H 7/00; G06T 3/00

(52) U.S. Cl. 345/441; 84/622; 702/150; 340/539.1

(57) ABSTRACT

A system and method of generating a representation or alteration of a subject. One or more devices may be attached to a subject, and a first signal transmitted towards the subject, the first signal interacting with the one or more devices to produce a second signal. The second signal may be received from the subject and data therein processed. A representation or alteration of the subject may then be generated as a function of the processed data.

### RELATED APPLICATIONS

The instant application is related to and co-pending with U.S. Patent Application No. [T2203-00013], filed ______ and entitled, “System, Device and Method for Providing Haptic Technology,” the entirety of which is incorporated herein by reference. The instant application is related to and co-pending with U.S. Patent Application No. [T2203-00014], filed ______ and entitled, “______,” the entirety of which is incorporated herein by reference. The instant application is related to and co-pending with U.S. Patent Application No. [T2203-00016], filed ______ and entitled, “______,” the entirety of which is incorporated herein by reference. The instant application is related to and co-pending with U.S. patent application Ser. No. 12/292,948, filed Dec. 1, 2008 and entitled, “Zeleny Sonosphere,” the entirety of which is incorporated herein by reference. The instant application is related to and co-pending with U.S. patent application Ser. No. 12/292,949, filed Dec. 1, 2008 and entitled, “Zeleny Therapeutic Sonosphere,” the entirety of which is incorporated herein by reference.

### BACKGROUND

Embodiments of the present subject matter generally relate to devices, systems and methods for determining motion of a subject. Further embodiments of the present subject matter may render a computer representation of a subject's self or alter ego, generally termed as an avatar, or generate synthesized music through a determination of physical and/or physiological information of the subject.

The use of radar for detection of physiological motion, e.g., related to respiratory rate and heart rate, is known. Generally, through the Doppler effect an electromagnetic wave reflected at a moving surface may undergo a frequency shift proportional to the surface velocity. If the surface is moving periodically, such as the chest of person breathing, this may be characterized as a phase shift proportional to the surface displacement. If the movement is small compared to the wavelength, e.g., when measuring chest surface motion related to heart activity, a circuit coupling both the transmitted and reflected waves to a mixer for comparison may produce an output signal with a low-frequency component directly proportional to the movement such that the heart rate can be derived. Commercially available waveguide Doppler transceivers have been shown to detect respiratory rate and heart rate of a relatively still and isolated subject. These devices, however, pose a challenge to obtain useful data of random motion of a human subject with or without peripheral human subjects, other moving objects, unknown or known number of subjects, and/or objects within range, and so on.

Various digital signal processing techniques have been employed to extract useful data from such measurements. When radar sensing is performed at a close proximity with a subject (e.g., less than 1 meter), similar motion artifacts from a subject's random motion are encountered and can be filtered out from the signal; however, if radar sensing is performed at a distance (e.g., greater than 1 meter), motion in the subject's background from other subjects and objects, in addition to movements by the subject's hands, head, etc. may affect the measurement. The use of higher (millimeter-wave) frequencies and more directive antennas may assisting in avoiding some background motion and noise; however, such systems are generally costly and require accurate aiming at the subject.

Accordingly, background noise (including both environment noise and the presence of multiple subjects) has been a barrier to many aspects of Doppler or radar sensing of physical and/or physiological motion whether from a single subject or multiple subjects. Thus, there is an unmet need to accurately determine the motion of a subject. Further, there is an unmet need to render a computer representation of a subject's avatar as a function of the determined motion.

### SUMMARY

One embodiment of the present subject matter may acknowledge differences in atomic density between a subject's tissue and embedded or subcutaneous metallic materials and generate information as a function of the detected, changing motion of the subject or object. Another embodiment of the present subject matter provides a method of generating a representation of a subject. The method may comprise the steps of attaching one or more devices to a subject and transmitting a first signal towards the subject, the first signal interacting with the one or more devices to produce a second signal. The second signal may be received from the subject and associated data processed. A representation of the subject may then be generated as a function of the processed data.

Another embodiment of the present subject matter may provide a method of generating a computerized representation of a subject. The method may include the steps of transmitting a first radio frequency (“RF”) signal towards a subject, receiving a second RF signal from the subject, and generating the representation as a function of information in the received second RF signal.

A further embodiment of the present subject matter provides a method of tracking the physical motion of an object. The method may comprise the steps of attaching one or more devices to an object and transmitting a set of first signals towards the object, the set of first signals interacting with the one or more devices to produce a set of second signals. The physical motion of the object may then be tracked as a function of information in the set of second signals.

One embodiment of the present subject matter provides another system for generating information from the motion of an object. The system may include one or more devices attached to an object and a transmitter for transmitting a first RF signal towards the object, the first signal interacting with the one or more devices to produce a second RF signal. The system may also include a receiver for receiving the second RF signal from the object, circuitry for processing data in the received second RF signal, and circuitry for generating information as a function of the processed data.

Another embodiment of the present subject matter provides a method of synthesizing music. The method may comprise the steps of attaching one or more devices to a subject, receiving a first signal from the subject and processing data from the received signal. Synthesized music may then be generated as a function of the processed data.

These embodiments and many other objects and advantages thereof will be readily apparent to one skilled in the art to which the present subject matter pertains from a perusal of the claims, the appended drawings, and the following detailed description of the embodiments.

### BRIEF DESCRIPTION OF THE DRAWINGS

Various aspects of the present disclosure will be or become apparent to one with skill in the art by reference to the following detailed description when considered in connection with the accompanying exemplary non-limiting embodiments.

FIG. 1 is a depiction of one embodiment of the present subject matter.

FIGS. 2 and 3 are depictions of exemplary radar systems according to embodiments of the present subject matter.

FIG. 4 is a depiction of an exemplary system according to one embodiment of the present subject matter.

FIG. 5 is an illustration of an exemplary system according to an embodiment of the present subject matter.

FIG. 6 is a diagram of a transponder according to an embodiment of the present subject matter.

FIG. 7 is an illustration of an injection system according to an embodiment of the present subject matter.

FIG. 8 is a diagram of one embodiment of the present subject matter.

FIG. 9 is a diagram of another embodiment of the present subject matter.

FIG. 10 is a diagram of a further embodiment of the present subject matter.

FIG. 11 is a diagram of an additional embodiment of the present subject matter.

### DETAILED DESCRIPTION

With reference to the figures where like elements have been given like numerical designations to facilitate an understanding of the present subject matter, the various embodiments of a system and method for determining motion of a subject are herein described.

The following description is presented to enable a person of ordinary skill in the art to make and use various aspects of the present subject matter. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the subject matter. Thus, the present subject matter is not intended to be limited to the examples described herein and shown, but are to be accorded the scope consistent with the claims.

The following description begins with a broad description of various exemplary radar sensing systems and methods, which may be used to detect the presence and motion of a subject and monitor and track a subject's motion. It may also be used to render an avatar of a subject as a function of information related to the physical and physiological motion or information of the subject. It should be noted that the terms or phrases transponder and small array tracking (SAT) point are utilized interchangeably throughout the disclosure and should not be construed as limiting the claims appended herewith.

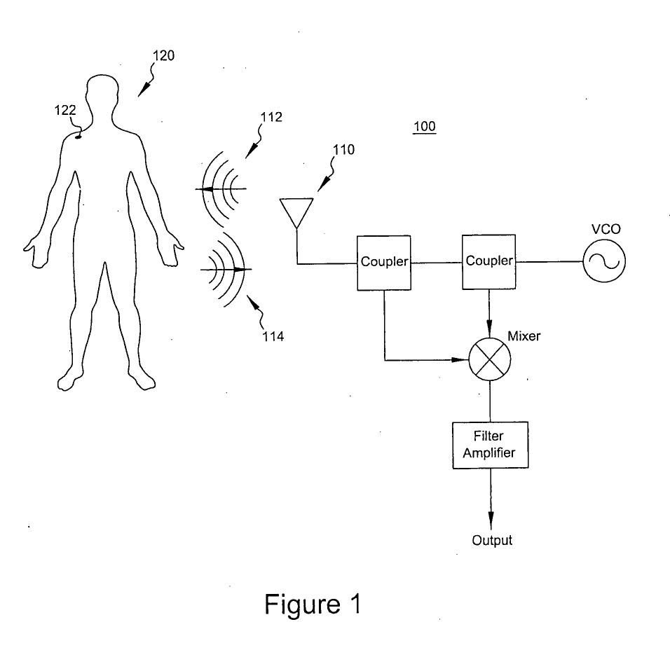

FIG. 1 is a depiction of one embodiment of the present subject matter. With reference to FIG. 1, an exemplary radar system 100 may include a single input single output antenna 110 for measuring motion associated with a subject 120. The exemplary radar system 100 may, in one non-limiting embodiment, comprise a continuous wave (CW) radar system transmitting a single tone signal 112 at a predetermined frequency. The transmitted signal 112 may be modulated (amplitude, frequency or phase) upon reflection from a subject at a nominal distance with or without a time-varying displacement.

In one embodiment, the received modulated signal 114 may be related to the transmitted source signal 112 with a time delay determined by the nominal distance of the subject 120 and with its phase modulated by the motion of the subject 120. Information about the subject's motion may be extracted if the received signal 114 is multiplied by a local oscillator (LO) signal (e.g., voltage controlled oscillator (VCO), voltage crystal controlled oscillator (VXCO), etc.) associated with the transmitted source signal 112 as illustrated in FIG. 1. For example, when the received and LO signals are mixed and then low-pass filtered, the resulting baseband signal may include the constant phase shift dependent on the distance to the subject and the periodic phase shift resulting from subject motion. Although illustrated as a CW radar system 100, other radar systems may be employed in embodiments of the present subject matter and such an example should not limit the scope of the claims appended herewith. For example, a frequency modulated CW (FM-CW) radar system or a coherent pulsed radar system may be similarly constructed and used for detecting motion of a subject. An exemplary radar system described here may transmit a source signal having a frequency in the range of 800 MHz to 10 GHz, however, lower and/or higher frequencies are also included in these embodiments.

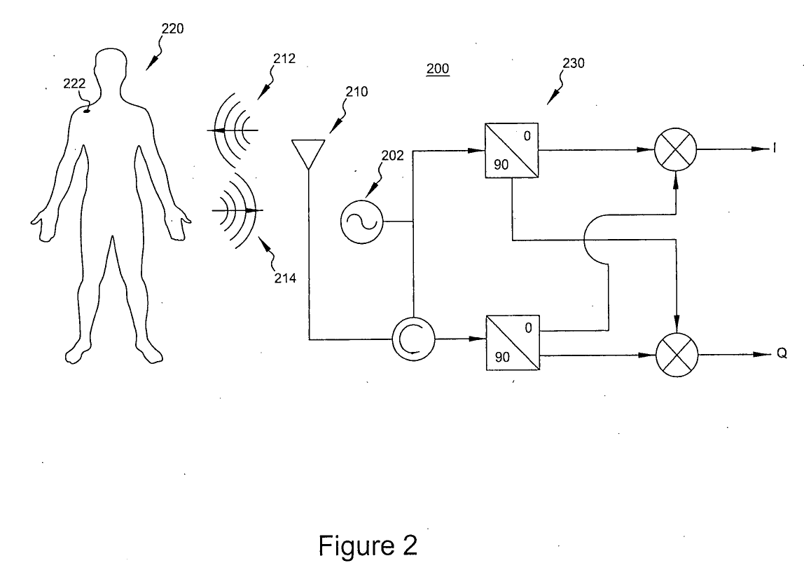

Additional exemplary radar systems according to embodiments of the present subject matter are illustrated in FIGS. 2 and 3. With reference to FIG. 2, an exemplary Doppler radar system 200 may include a quadrature receiver 230 and transceiver antenna 210. The system 200 may operate to extract a phase shift proportional to the movement of the subject 220. In this embodiment, a VCO 202 may provide both a source signal for transmission 212 and a LO signal. The LO signal may be divided by a splitter to obtain orthogonal baseband signals for mixing with the received, modulated signal 214. The two or more baseband signals may be mixed with the received signals to provide I and Q outputs and compared to determine phase and amplitude imbalance factors.

FIG. 3 is similar to that of FIG. 2, however, the exemplary radar system 300 illustrated includes two receivers 330 in communication with two receiver antennas 310 and at least one transmitter antenna 311. In another embodiment, the transmitter antenna 311 may be located remotely or locally to one or both of the receivers 330 and/or receiver antennas 310. In this embodiment, both receivers 330 may be quadrature receivers. The system 300 may receive a transmitted source signal from a VCO 302 and mix the signal with the received signals from the receiver antenna(s) 310. The system 300 may also split the source signal and mix the received transmitted signal. The systems described above may also include analog and digital stages, and it should be recognized by those of ordinary skill in the art that various other components and configurations of components are possible to achieve the described operation of the receivers. Further, various Doppler radar sensing systems and methods described herein may be implemented alone or in combinations with various other system, methods and may employ a number of processing speeds. For example, a system may combine exemplary systems described with respect to FIGS. 1-3 to include one or more transmitters, one or more receivers, or one or more transceivers (and associated antennas).

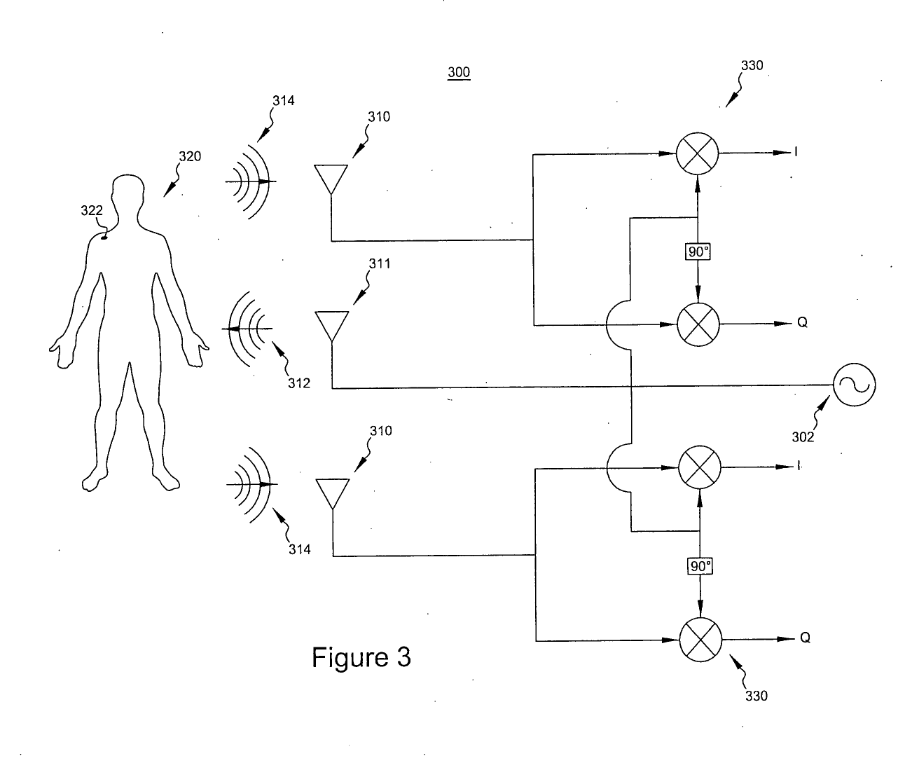

FIG. 4 is a depiction of an exemplary measurement system according to one embodiment of the present subject matter. With reference to FIG. 4, a measurement or processing system 400 may be employed to implement processing functionality for various aspects of the subject matter (e.g., as a transmitter, receiver, transceiver, radar system, processor, music synthesizer, memory device, and so on). Those skilled in the relevant art will also recognize how to implement the subject matter using other computer systems or architectures. The system 400 may represent, for example, a desktop, mainframe, server, memory device, mobile client device, or any other type of special or general purpose computing device as may be desirable or appropriate for a given application or environment. The system 400 may also include one or more processors, such as a processor 404 implementable using a general or special purpose processing engine such as, for example, a microprocessor, microcontroller or other control logic. In this example, the processor 404 may be connected to a bus 402 or other communication medium.

The system 400 may include a main memory 408, e.g., random access memory (RAM) or other dynamic memory, for storing information and instructions to be executed by the processor 404. The memory 408 may be used for storing information during execution of instructions executable by the processor 404. The system 400 may include a read only memory (ROM) or other static storage device coupled to the bus 402 for storing static information and instructions for the processor 404. The system 400 may also include any number of storage mechanisms 410, including, for example, a media drive and removable storage interfaces, and storage available through extra-modular means, such as Internet sites catering to such services. The media drive may include a drive or other mechanism to support fixed or removable storage media. Exemplary media drives may be, but are not limited to, a hard disk drive, a floppy disk drive, a magnetic tape drive, an optical disk drive, a CD or DVD drive, or other removable or fixed media drive. Exemplary storage media may include, but are not limited to, a hard disk, floppy disk, magnetic tape, optical disk, CD or DVD, or other fixed or removable medium read by and/or written to by a media drive.

In alternative embodiments, the storage mechanisms 410 may include other similar instrumentalities for allowing computer programs or other instructions or data to be loaded into the system 400. Such instrumentalities may include, for example, a removable storage unit and interface, such as a program cartridge and cartridge interface, a removable memory (e.g., flash memory or other removable memory module), use of instructions from Internet sources, memory slots, and other removable storage units and interfaces allowing transfer of software and data. The system 400 may also include a communications interface 406. The communications interface 406 may be employed to allow software and data to be transferred between the system 400 and external devices or systems 420. Examples of an exemplary communications interface 406 include a modem, a network interface (such as an Ethernet or other network interface card), a communications port (such as for example, a universal serial bus port), a personal computer memory card international association (PCMCIA) slot and card, etc. Software and data transferred via the communications interface 406 may be in the form of signals which can be electronic, electromagnetic, optical, or other signals capable of being received by communications interface 406. These signals are provided to communications interface 406 via one or more channels 412 adaptable to carry signals and may be implemented using a wireless medium, wire or cable, fiber optics, or other communications medium and may also be digital or analog signals. Exemplary channels may include a phone line, a cellular phone link, an RF link, a network interface, a local or wide area network, and the like. Exemplary external devices or systems 420 may be, but are not limited to, the radar systems generally depicted and described in the figures and attendant description thereof.

It will be appreciated that, for clarity purposes, the above description has described embodiments of the present subject matter with reference to different functional units and processors. However, it will be apparent that any suitable distribution of functionality between different functional units or processors may be used without detracting from the present subject matter. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Subjects 120, 220, 330, 530 depicted in FIGS. 1-3 and 5 may include or wear one or more transponders 122, 222, 322, 522 or SAT points or an array thereof, each operable to move in conjunction with the subject's motion. In one embodiment, a subject may have transponders located at predetermined points (e.g., joints, cheek, jaw, eyelids, eyebrows, pupil-tracking hardware, lips, ears, forehead, hands, appendages, torso, etc.) in wearable fashion or subcutaneously. The transponders may be active and operate with incident radio frequency (RF) signals (see FIGS. 1-3 and 5) to produce a return signal that may be more readily detected. The transponders may also be passive and merely reflect an incident signal thereon. In one embodiment of the present subject matter, a transponder may alter an incident signal and provide a return signal altered in frequency and/or time which may allow for improved isolation of signals associated with subjects from noise and/or extraneous reflections. Of course, the transponder may generate a signal independent of information in an incident RF signal. Additionally, such transponders may assist in distinguishing detected subjects from other subjects in the immediate vicinity, whether or not the other subjects are also wearing transponders.

In another embodiment, an exemplary transponder may include Radio Frequency Identification (RFID) circuitry adaptable to isolate an incident RF signal thereon from the return signal by a predetermined shift in frequency. One simple form of an exemplary circuit may be based on a Schottky diode that multiplies the frequency of an incident signal and generates an output signal tuned or filtered for a desired harmonic. Thus, exemplary RFID circuitry in a transponder may operate to reradiate an incident signal of frequency at a new frequency that may be more easily isolated from a transmitted signal or background noise. A further embodiment may provide a transponder or SAT point comprising a bio-compatible or biologically safe metal encased in a polyethylene or ceramic shell or substrate.

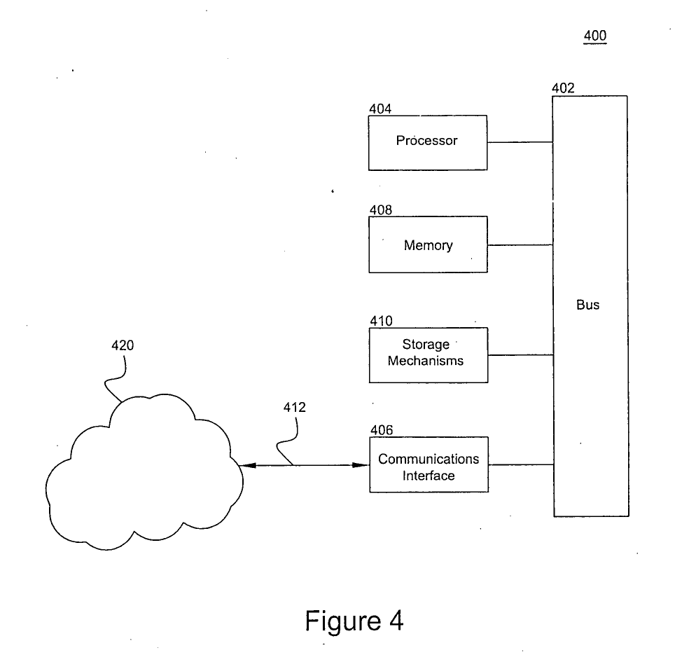

One exemplary system according to an embodiment of the present subject matter is illustrated in FIG. 5. With reference to FIG. 5, a radar sensor system 500 may be configured to transmit a source signal 512 at a first frequency via a transmitting antenna 510 and receive a modulated signal 514 at a second frequency via a receiver antenna 511. Of course, the transmitting and receiving antennas may be a single transceiver antenna. The radar sensor system 500 may operate to interrogate a transponder 522 on or in a subject 530, ignore or filter return signals at the original interrogation frequency including those reflected from stationary objects, other subjects, and other parts of the body of the subject 530, and/or accept those signals 514 altered or reflected by the transponder 522 (depending upon the active/passive nature thereof, by means of simple mass detection of the SAT Points' or transponders' metallic density). In one such embodiment, no transmission or radiation of any kind would be occurrent from the SAT Point(s) or transponder(s). Thus, motion of the subject and/or desired body parts may be specifically detected as a phase shift in the multiplied signal, as compared by the mixer to a correspondingly multiplied sample of the original signal. Additional data may also be introduced as modulation on the circuitry of an exemplary transponder 522. Thus, in addition to improving sensitivity and isolation for a return signal, exemplary transponders 522 may also provide additional data associated with tagged subjects. For example, electrodes and/or transponders adjacent the skin (e.g., clothing, wearable articles) or subcutaneous electrodes and/or transponders may also be employed to sense bioelectric information such as muscle movement, perspiration, heart signals and impose such information as a bias at a diode or other circuitry in the transponder to periodically interrupt the reflection signal and provide additional information. Thus, information contained in the transponders may be non-biological in nature, including but not limited to, schematics for how one or multiple avatars may appear to themselves and to other users. By way of further example, utilizing components in an exemplary RF circuit of the transponder, a reflected signal may be altered and effectively encoded with data associated with information sensitive to biological parameters of the subject, personal parameters of the subject, previously-generated medical information, biographical information, and/or secured “credit card” and financial information to be scanned through one of many means by an appropriate third party.

In one embodiment, a transponder for providing physical and/or physiological information of a subject may include a thermally controlled variable RF inductor. Generally, thermally controlled variable RF inductors are based on the manipulation of interlayer stress between sandwiched thin films of conductive and non-conductive material. For example, an inductor made of multiple turns aligning at one temperature may misalign at other temperatures and vary the mutual component of the device's inductance. Such a transponder may provide the necessary frequency shift in time/frequency shifting circuits, and physical misalignment of structures in the transponder would be employed to sense joint motion, appendage motion, skin-surface pressure or motion due to subcutaneous blood flow, and so forth.

In yet another embodiment, a transponder may or may not include electrodes and may be configured for positioning adjacent or under the skin of a subject. This embodiment may be wearable (in a full-body suit or other garment such as shirt, pants, hats, gloves, shoes, etc.), may be applied as one or more patches (or the like), or may be subcutaneous. For example, a 2-lead electrode to detect bioelectric potential may be included with a transponder for conveying 2-lead data, such as electrical heart activity, respiratory activity, etc. to provide complimentary data with the motion of a subject. Thus, combined radar and bioelectric data may provide more complex physical and physiological information or data for a user of an exemplary system according to an embodiment of the present subject matter. An exemplary transponder may thus be realized in a low-cost, disposable and/or easily applied package. While one such embodiment may be an adhesive patch-type device, various other suitable devices will be apparent to those of ordinary skill in the art, and depending on the particular application, need not be affixed to the skin of a subject and may be affixed to clothing or worn around the neck, wrist, other joints and/or appendages, etc. In another embodiment of the present subject matter, transponders or SAT points may be employed in vehicles (e.g., located on exemplary dimensional points of the vehicle) and utilized in conjunction with automated highway tracking and management technologies. In the vehicular embodiment, the transponder metal may be differentiated from that of the vehicle.

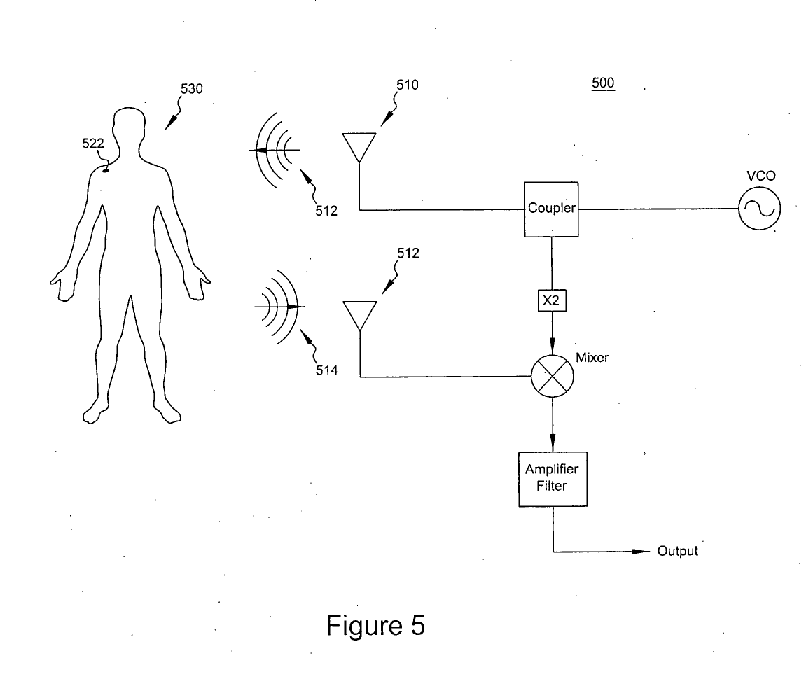

Exemplary active transponders according to embodiments of the present subject matter may also operate without implanted batteries and may thus communicate information and be powered without wired connections. These exemplary transponders may receive energy and information and may transmit energy and information using the flux of an incident RF signal or electromagnetic field. FIG. 6 is a diagram of a transponder according to another embodiment of the present subject matter. With reference to FIG. 6, a block diagram depicts a transponder 600 implantable beneath a layer of skin 610 of a subject. The transponder 600 may be used to communicate data to an external device or system 620. The transponder 600 may also be used to provide electrical stimulation to the skin 610 (or other tissue) via a stimulus electrode 602 in response to a signal from the device, system 620 or user(s). Of course, the transponder 600 may wirelessly interact with other systems or may interact via direct electrical connection with other systems. For example, the transponder 600 may include electrical components 604 adapted to interface or interact with other transponders implanted within the body of a subject and/or other external receivers and other devices. The wireless capability of the transponder 600 may thus enable the delivery of electrical signals to peripheral nerve tissue and signals configured to stimulate peripheral nerves distributed throughout subcutaneous tissue of the subject. Among the many medical applications of an exemplary transponder 600, may be the surgical implanting of the transponder(s) 600 at the vegas nerve. Tiny impulses may be employed to correct common hiccups, epilepsy and major depression. When surgically implanted at or near exemplary nerves associated with a heart's mitral valve region, medical employment of embodiments of the present subject matter may include correction of atrial fibrillation and other arrhythmias. When applied to the bloodstream, exemplary nano-sized, transponders 600 may be employed to destroy cells containing biological contaminants and/or genetic defects via the use of radio waves, sonic and/or ultrasonic frequency emission, microwaves and other means, especially when used in conjunction with the embodiments described in co-pending U.S. patent application Ser. No. 12/292,948, filed Dec. 1, 2008 and U.S. patent application Ser. No. 12/292,949, filed Dec. 1, 2008 the entirety of each are incorporated herein by reference.

The transponder 600 may operate as an autonomous wireless unit, capable of detecting signals generated by peripheral nerves or received from an external system 620 and relay such signals to external systems 620 for further processing. In this embodiment, the transponder 6200 may perform such operations as a function of received external RF electromagnetic signals. The above-mentioned capabilities are facilitated by the fact that magnetic fields are not readily attenuated by human tissue thus enabling the RF electromagnetic signals to sufficiently penetrate the human body so signals may be received and/or transmitted by the transponder 600.

It should be appreciated in certain embodiments, the RF capabilities of an exemplary transponder may render it a passive device without reacting to any incoming carrier RF signals. Thus, the transponder would not actively emit any signals but would rather reflect and/or scatter the electromagnetic signals of an incident carrier RF wave as a function of the density of the transponder to provide signals receivable by a radar system according to an embodiment of the present subject matter. It should be understood that, in certain embodiments, the minimum size for the transponders may be limited by the size of the complementary circuits for the specific application. Exemplary transponders may range from less than 1 nanometer in diameter and a few nanometers thick to an eighth or half of an inch in diameter and a few millimeters thick. These transponders may provide sufficient wireless power to operate any complex electronics that can be manufactured.

Exemplary fabrication technologies for the various implementations may include thin and thick film polymers, electroplated contacts and RF conductors, micro- and nano-machined circuits, electrodes or transponders, and nanotechnology, microelectromechanical systems (MEMS), organic field effect transistors (OFET) (including OFETs having ultra-fast biodegradability), or other transducer components that may be integrated on flexible carriers or substrates. Exemplary transponders may be fabricated using known multi-layer and MEMS fabrication techniques.

In one embodiment, a layer of biologically safe metal, e.g., gold, titanium, and the like, may be electroplated onto a substrate, such as a ceramic or organic based material(s). Other substrate materials may also be employed that are compatible with the conducting material used for the metallic layer (e.g., silicone elastomers, silicone hydrogels, plastics, polyethylene, gelatins, collagen, etc.). Depending upon the embodiment, the metallic layer may also be encased by the substrate material or ceramic or organic based material(s). Electroplated gold may be preferred as a conductor material due to its high conductivity, resistance to oxidation, and proven ability to be implanted in biological tissue. It should be appreciated, however, that other conducting materials can also be used as long as the material exhibits the conductivity and oxidation resistance characteristics required by the particular application to which the transponder would be applied. The geometry of the electroplated metal may also vary according to the particular application to which the transponder would be applied; thus, as will be apparent to one of ordinary skill in the art, the scope of the present subject matter encompasses any combination of conductor widths, spacings and/or configurations. Depending upon the transponder embodiment, other components (capacitors, diodes, semiconductor chips, etc.) may be fabricated and/or attached to the transponder using various conducting layers, sacrificial seed layers, electrical connections, optical printing and the like. Thus, many different methods may be utilized to fabricate the exemplary transponders as described. For example, various other semiconductor, MEMS, and nanotechnology processing techniques may be employed.

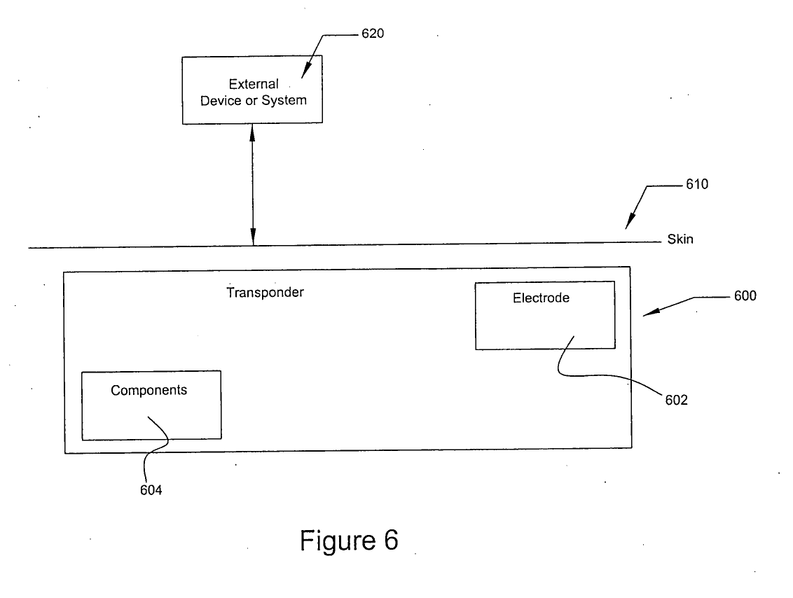

FIG. 7 is an illustration of an injection system according to an embodiment of the present subject matter. With reference to FIG. 7, an injection system 700 may comprise a cannula or needle 702 and stylus 704 adaptable to push through the needle 702. The front tip 701 of the needle 702 may include an extruded edge 706 adaptable to guide loaded transponders 710 into a target body location 730. Transponders 710 may be deposited while pushing through the stylus 704 and retracting the needle 702. Notches (not shown) may also be employed to prevent accidental, multiple implantations of exemplary transponders 710. The needle 702 is illustrated as a beveled rectangular hypodermic needle, however, one of ordinary skill in the art would understand that any manner of needle may be employed to deposit exemplary transponders 710 in a subject. Following the placement of transponders 710 into the needle 702, the needle 702 may be carefully withdrawn from a subject and the transponder 710 configuration and operation evaluated. Evaluation of the transponder 710 may be conducted utilizing a temporary RF transmitter placed proximate the location where the transponder(s) 710 is implanted, so the subject can report any stimulation, sensitivity, and the like.

Exemplary transponders may attach to a subject in any of a number of ways, including a wristband, necklace, ankle bracelet, wristwatch, pin, identification card or a subcutaneous capsule, for example. Further transponders may include verification data, such as biometric verification data, for example in a form of a digital photograph of the subject or other variable and programmable data regarding the subject. The amount of data is only limited by the amount of memory available in the transponder.

In conjunction with an exemplary radar system described above (FIGS. 1-3 and 5) and the attendant or associated processing or measuring system (FIG. 4), a computer representation of a subject's avatar may be rendered as a function of the physical and/or physiological information received from the transponders. Generally, an avatar may essentially represent a subject's physical representation or a fantastical representation or model in a virtual environment. Software, be it written by the user(s) in a developmental computer program or be it from “ready-to-use” Internet-downloadable packages, or other computer readable media in an exemplary system 400 may allow customization of a subject's avatar, physical features, gender, etc. and may be employed to render a human likeness or fantastical representation of a subject's self, alter ego or otherwise. Thus, an embodiment of the present subject matter may utilize existing radar technology, track plural SAT points or transponders on a subject and any information associated therewith, and render an avatar having a similar or fantastical likeness to the subject that mimics the movement and/or facial expressions of the subject as a function of the motion of the SAT points or transponders. In yet another embodiment of the present subject matter, transponders or SAT points (mounted in garments and/or subcutaneously placed) may be interfaced with synthesized music applications available in an exemplary system 400 so that by dancing and/or moving at varying degrees, speeds, angles, and locations in empty space, a performer may operate one or several synthesized instruments at once. The music may thus be played solely by the movement of a performer via tracked transponders or SAT points and utilizing embodiments of the present subject matter as described above.

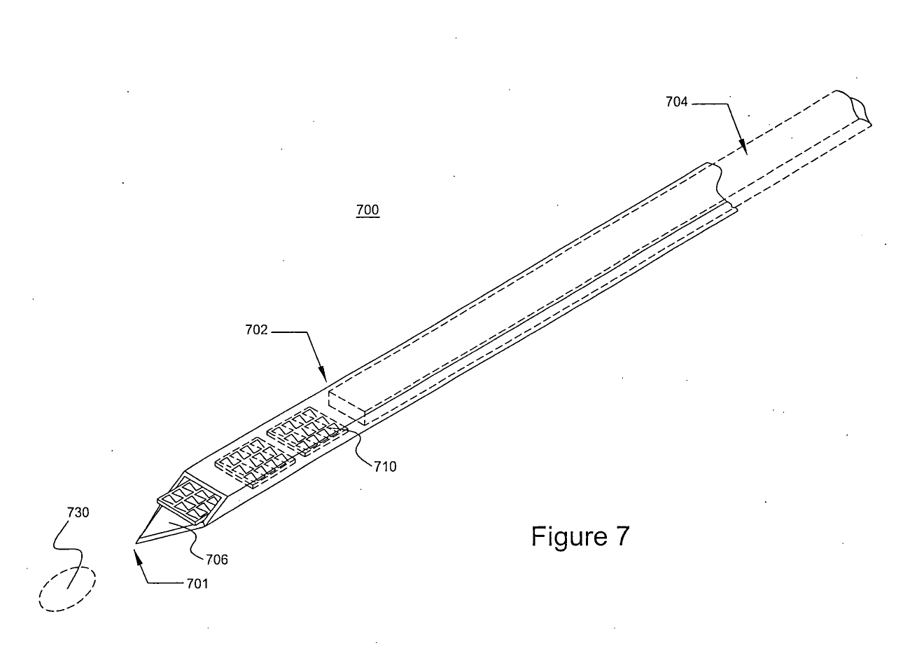

FIG. 8 is a diagram of one embodiment of the present subject matter. With reference to FIG. 8, a method 800 is provided for generating a representation of a subject. At step 810, one or more devices may be attached to a subject. In one embodiment, the devices may be active or passive transponders and may comprise biologically safe metals and substrate materials. In another embodiment, step 810 may include implanting the one or more devices subcutaneously in the subject, and/or may include affixing the one or more devices to a garment, and/or found object containing stated transponders which are at once merged with the overall software profile of the user, and/or may include attaching one or more adhesive patches to the subject, a patch containing one of the devices. Exemplary garments may be, but are not limited to, tools, shirts, suits, gloves, hats, goggles, spectacles, shoes, pants, socks, undergarments, clothing accessories, necklaces, bracelets, jewelry, and combinations thereof. At step 820, a first signal may be transmitted towards the subject, the first signal interacting with the one or more devices to produce a second signal. In one embodiment, step 820 may include reflecting the first signal incident on the one or more devices to produce the second signal or altering the first signal incident on the one or more devices to produce the second signal. Of course, the second signal may be produced independent of information in the first signal. The second signal may be received from the subject at step 830, and data in the received second signal processed at step 840. At step 850 a representation of the subject may be generated as a function of the processed data. The representation may be a computerized likeness of the subject, a known celebrity/historical figure, or a fantastical representation.

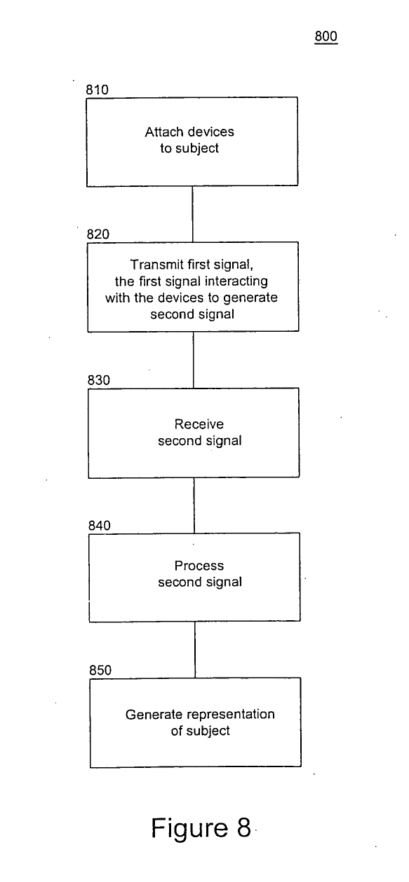

FIG. 9 is a diagram of another embodiment of the present subject matter. With reference to FIG. 9, a method 900 is provided for generating a computerized representation of a subject. At step 910, a first RF signal may be transmitted towards a subject. At step 920, a second RF signal may be received from the subject, and at step 930, a representation may be generated as a function of information in the received second RF signal.

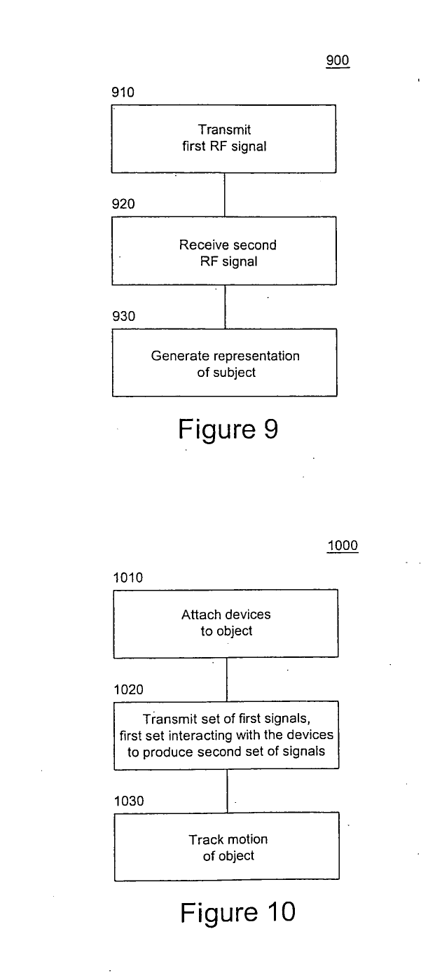

FIG. 10 is a diagram of a further embodiment of the present subject matter. With reference to FIG. 10, a method 1000 is provided for tracking the physical motion of an object. The object may be, but is not limited to, a human, an animal, a vehicle, an inanimate object. At step 1010, one or more devices may be attached to an object. In one embodiment, the devices may be active or passive transponders and may comprise biologically safe metals and substrate materials. In another embodiment, the one or more devices may be subcutaneous implants, adhesive patches and/or affixed to a garment. Exemplary garments may be, but are not limited to, tools, type-character or musical keyboards, shirts, suits, gloves, hats, goggles, spectacles, shoes, pants, socks, undergarments, clothing accessories, necklaces, bracelets, jewelry, and combinations thereof. At step 1020, a first set of signals may be transmitted towards the object(s), the first set of signals interacting with the one or more devices to produce a second set of signals. In one embodiment, step 1020 may include reflecting ones of the first set of signals incident on the one or more devices to produce the second set of signals or may include altering ones of the first set of signals incident on the one or more devices to produce the second set of signals. Of course, the second set of signals may be produced independent of information in the first set of signals. At step 1030, any motion of the object may then be tracked as a function of information in the set of second signals.

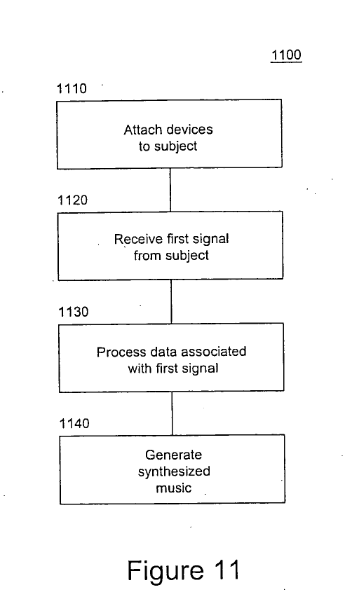

FIG. 11 is a diagram of an additional embodiment of the present subject matter. With reference to FIG. 11, a method 1100 is provided for synthesizing music. At step 1110, one or more devices may be attached externally to or subcutaneously in a subject. In one embodiment, the devices may be active or passive transponders and may comprise biologically safe metals and substrate materials. In another embodiment, step 1110 may include implanting the one or more devices subcutaneously in the subject, and/or may include affixing the one or more devices to a garment, and/or may include attaching one or more adhesive patches to the subject, the patches containing ones of the devices. Exemplary garments may be, but are not limited to, tools, type-character or musical keyboards, shirts, suits, gloves, hats, goggles, spectacles, shoes, pants, socks, undergarments, clothing accessories, necklaces, bracelets, jewelry, and combinations thereof. At step 1120, a first signal may be received from the subject and associated data thereof processed at step 1130. At step 1140, synthesized music may then be generated as a function of the processed data. In one embodiment, step 1140 may include generating synthesized music as a function of the physical motion of the one or more devices. In another embodiment, the method 1100 may include the step of transmitting another signal towards the subject, the other signal interacting with the one or more devices to produce the first signal. This additional step may further comprise reflecting the first signal incident on the one or more devices to produce the second signal or may further comprise altering the first signal incident on the one or more devices to produce the second signal. Of course, the first signal may be produced independent of information in the other signal.

It should be noted that, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate. As shown by the various configurations and embodiments illustrated in FIGS. 1-11, a system and method for determining motion of a subject have been described.

While preferred embodiments of the present subject matter have been described, it is to be understood that the embodiments described are illustrative only and that the spirit and scope of the present subject matter is to be defined solely by the appended claims when accorded a full range of equivalence, many variations and modifications naturally occurring to those of skill in the art from a perusal hereof.

I claim:

1. A method of generating a representation of a subject comprising the steps of:
attaching one or more devices to a subject;
transmitting a first signal towards the subject, the first signal interacting with the one or more devices to produce a second signal;
receiving the second signal from the subject;
processing data in the received second signal; and
generating a representation of the subject as a function of the processed data.

2. The method of claim 1 wherein the devices are selected from the group consisting of: active transponders, passive transponders, subcutaneous implants, devices affixed to a garment, adhesive patches, and injected devices.

3. The method of claim 1 wherein the step of attaching further comprises implanting the one or more devices subcutaneously in the subject.

4. The method of claim 1 wherein the step of attaching further comprises affixing the one or more devices to a garment.

5. The method of claim 4 wherein the garment is selected from the group consisting of a shirt, suit, glove, hat, goggles, spectacles, shoes, pants, socks, undergarments, clothing accessories, necklaces, bracelets, jewelry, tools, type-character or musical keyboards, and combinations thereof.

6. The method of claim 1 wherein the step of attaching further comprises attaching one or more adhesive patches to the subject, the patches containing ones of the devices.

7. The method of claim 1 wherein the step of transmitting further comprises reflecting the first signal incident on the one or more devices to produce the second signal.

8. The method of claim 1 wherein the step of transmitting further comprises altering the first signal incident on the one or more devices to produce the second signal.

9. The method of claim 1 wherein the second signal is produced independent of information in the first signal.

10. The method of claim 1 wherein the representation is a computerized likeness of the subject or a fantastical representation.

11. The method of claim 1 wherein the one or more devices comprises a biologically safe metal and a substrate material.

12. The method of claim 1 wherein the step of attaching further comprises injecting the one or more devices into the subject.

13. In a method of generating a computerized representation of a subject the improvement comprising the steps of transmitting a first radio frequency (“RF”) signal towards a subject, receiving a second RF signal from the subject, and generating the representation as a function of information in the received second RF signal.

14. A method of tracking the physical motion of an object comprising the steps of:
attaching one or more devices to an object;
transmitting a set of first signals towards the object, the set of first signals interacting with the one or more devices to produce a set of second signals; and
tracking motion of the object as a function of information in the set of second signals.

15. The method of claim 14 wherein the devices are selected from the group consisting of: active transponders, passive transponders, subcutaneous implants, devices affixed to a garment, adhesive patches, and injected devices.

16. The method of claim 15 wherein the garment is selected from the group consisting of a shirt, suit, glove, hat, goggles, spectacles, shoes, pants, socks, undergarments, clothing accessories, necklaces, bracelets, jewelry, tools, type-character or musical keyboards, and combinations thereof.

17. The method of claim 14 wherein the step of transmitting further comprises reflecting ones of the first set of signals incident on the one or more devices to produce the second set of signals.

18. The method of claim 14 wherein the step of transmitting further comprises altering ones of the first set of signals incident on the one or more devices to produce the second set of signals.

19. The method of claim 14 wherein the second set of signals is produced independent of information in the first set of signals.

20. The method of claim 14 wherein the object is selected from the group consisting of a human, an animal, a vehicle, an inanimate object.

21. A method of synthesizing music comprising the steps of:
attaching one or more devices to a subject;
receiving a first signal from the subject;
processing data from the received signal; and
generating synthesized music as a function of the processed data.

22. The method of claim 21 further comprising the step of transmitting another signal towards the subject, the another signal interacting with the one or more devices to produce the first signal.

23. The method of claim 22 wherein the step of transmitting further comprises reflecting the first signal incident on the one or more devices to produce the second signal.

24. The method of claim 22 wherein the step of transmitting further comprises altering the first signal incident on the one or more devices to produce the second signal.

25. The method of claim 22 wherein the first signal is produced independent of information in the another signal.

26. The method of claim 21 wherein the devices are active or passive transponders.

27. The method of claim 21 wherein the step of attaching further comprises a step selected from the group consisting of: implanting the one or more devices subcutaneously in the subject; affixing the one or more devices to a garment; and attaching one or more adhesive patches to the subject each patch containing one of the devices.

28. The method of claim 21 wherein the step of generating further comprises generating synthesized music as a function of the physical motion of the one or more devices.

29. A system for generating information from the motion of an object comprising the steps of:
one or more devices attached to an object;
a transmitter for transmitting a first radio frequency (“RF”) signal towards the object, the first signal interacting with the one or more devices to produce a second RF signal;
a receiver for receiving the second RF signal from the object;
circuitry for processing data in the received second RF signal; and
circuitry for generating information as a function of the processed data.

30. The system of claim 29 wherein the devices are active or passive transponders.

31. The system of claim 29 wherein the one or more devices are selected from the group consisting of subcutaneous implants, affixed devices in a garment, adhesive patches, injected devices, and combinations thereof.

32. The system of claim 29 wherein the second RF signal is a reflection of the first RF signal or is independent of the first RF signal.

33. The system of claim 29 wherein the second RF signal is a substantial alteration of the first RF signal, said alteration occurring by the one or more devices.

34. The system of claim 29 wherein the information is synthesized music generated as a function of physical motion of the one or more devices.

35. The system of claim 29 wherein the one or more devices comprises a biologically safe metal and a substrate material.

36. The system of claim 29 wherein the object is selected from the group consisting of a human, an animal, a vehicle, an inanimate object.
